(19) United States
(12) Patent Application Publication
(10) Pub. No.: US 2006/0253322 A1
(43) Pub. Date: Nov. 9, 2006

(54) Method and apparatus for incorporating advertising into trays

(76) Inventor: Mark W. Trahan, Wethersfield, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/146,444

(22) Filed: Jun. 6, 2005

Related U.S. Application Data
(63) Continuation-in-part of application No. 11/115,557, filed on Apr. 26, 2005.

(51) Int. Cl. G07G 1/14

(52) U.S. Cl. 705/14

(57) ABSTRACT

A method for providing an advertising service using trays having advertising material displayed thereon comprises the steps of proposing an advertising campaign to a product/service provider, negotiating an agreement with the provider, providing a plurality of trays, determining the advertising material to be used with the trays, positioning the material on the trays, supplying at least a portion of the trays having the advertising material, and periodically replacing the advertising in the trays or collecting the trays and replacing them with different trays having different advertising. Each tray defines at least one generally exposed surface and has a cover releasably coupled thereto. At least a portion of the cover extends over at least a portion of the exposed surface. The cover is at least partially transparent or at least partially translucent to allow desired portions of advertising material to be viewed by a person looking at the tray.

### CROSS REFERENCE TO RELATED APPLICATION

This application is a continuation-in-part application of U.S. patent application Ser. No. 11/115,557, filed Apr. 26, 2005, the disclosure of which is incorporated herein by reference in its entirety.

### FIELD OF THE INVENTION

This invention generally relates to advertising and, more particularly, to the incorporation of advertising into, and the supply of advertising for use with, trays of the type found in cafeteria-style restaurants or at airport security check points.

### BACKGROUND OF THE INVENTION

Advertising has grown over the last few decades into a multi-billion dollar industry. In the past, advertising has traditionally been limited to billboards, television, and publications such as newspapers and magazines. Recently, however, new venues for advertising have been exploited. The advertising industry has recognized the potential for displaying advertising materials in non-traditional places where there is a captive audience, such as where groups of people must wait, often in lines, for extended periods of time. For example, television-type monitors displaying targeted ads have been incorporated into elevators and even into self-serve gasoline pumps. Because television-type monitors are employed, the advertising displayed thereon is easily changed often remotely.

Other opportunities for advertising exist where the use of monitors is not practical or possible and where changing the advertising materials can prove to be problematic. For example, at airports thousands of trays for temporarily retaining a person's belongings as they are passed through an X-ray or like machine are used at security checkpoints. While these security trays could provide an effective medium upon which to display advertising, changing the ads, targeting the ads to specific markets, dealing with airports and security issues, as well as selling the advertising could prove difficult and to date, has not been done.

Based on the foregoing, it is the general object of the present invention to provide a method and apparatus for incorporating advertising into security trays that overcomes the problems and drawbacks set forth herein above.

### SUMMARY OF THE INVENTION

The present invention resides in one aspect in a tray for displaying advertising material on a surface thereof. The tray defines at least one generally exposed surface. A cover is releasably coupled to the tray with at least a portion of the cover extending over at least a portion of the exposed surface. The cover is one of at least partially transparent and at least partially translucent to allow desired portions of advertising material positioned between the exposed surface and the cover to be viewed by a person looking at the tray.

Preferably the trays are of the type found at airport security checkpoints or in cafeteria-style restaurants. It is also preferable that the generally exposed surface be the bottom of the tray. However, the present invention is not limited in this regard as the sidewalls of a tray can also be employed.

The advertising material may be coupled to the exposed surface of the tray using mechanical fasteners, adhesives, magnets, or hook and loop fasteners. However, the present invention is not limited in this regard as the advertising material may also be sandwiched between the cover and the exposed surface, fastened directly to the tray, or slid into a pocket coupled to the tray. If fastened directly to the tray, the advertising material may be attached using snaps, channels, or the like, or it may be held underneath covers that are snapped, held in channels, or held in place using similar means. The advertising material may alternatively be printed directly on the trays, which may be disposable. In order to make more efficient use of advertising space, the advertising material may be printed on two sides of one sheet, and the one sheet may be reversed after a period of time to expose the opposing side thereof.

The present invention also resides in the modification of conventional non-advertising trays to accept advertising material. For example, existing trays may be fitted with anchors or other female couplers that can receive male connectors. The male connectors may be connected to transparent or translucent covers and fitted to the female couplers to retain advertising materials on the trays in a press-fit configuration, or they may be connected to or through the advertising material directly to mount the material on the trays.

The present invention resides in another aspect in a method for providing trays to a facility (such as an airport or other travel facility, a cafeteria (in, for example, a hospital, a school, an airport, a train station, a bus depot, a shopping mall), or the like), each tray having advertising material displayed thereon. The method includes providing a plurality of trays, each defining at least one generally exposed surface and having a cover releasably coupled thereto. At least a portion of the cover extends over at least a portion of the exposed surface and is one of at least partially transparent and at least partially translucent to allow desired portions of advertising material when such is positioned between the exposed surface and the cover to be viewed by a person looking at the tray. The specific advertising material to be used with the plurality of trays is determined and the advertising material is positioned between the exposed surface of each of the trays and the cover. At least a portion of the trays having the advertising material positioned therein, is delivered to a particular facility for use therein. Periodically the advertising is changed in the trays by either replacing the advertising in the trays or providing a supply of different trays having new advertising material positioned therein.

In additional aspects, the present invention resides in various methods for providing trays to airports and other facilities, each tray having advertising materials displayed thereon. In the first additional aspect, the airport or other end user would provide the trays. An initial step in this method would be for the end user to propose an advertising campaign to a product/service provider. An agreement would then be negotiated with the product/service provider. The trays would be provided and the advertising material to be used with the trays determined. The advertising material would then be associated with the trays, and the trays put into service by the end user. In the second additional aspect, the method resides in an advertising agency providing an advertising service to an airport wherein the advertising agency contacts a product/service provider and proposes an advertising campaign wherein the advertising material would be incorporated into the trays. An agreement with the product/service provider is negotiated, and the placement of trays in the airport is secured. In the third additional aspect, the method resides in the airport and the advertising agency entering into a joint venture and providing an advertising service to the airport. The service is proposed to a product/service provider, an agreement is negotiated, and trays having advertising material incorporated therein are provided to the airport. In the fourth additional aspect, the method resides in a tray manufacturer (or tray provider) and a product/service provider entering into a joint venture, proposing an advertising campaign to an airport, negotiating an agreement with the airport, and securing the placement of trays in the airport. In a fifth additional aspect, the method resides in a travel facility (e.g., an airport or the like), a product/service provider, and an authoritative agency (e.g., the Transportation and Safety Administration) entering into an agreement to provide advertising trays to the travel facility. In any of the foregoing additional aspects or any further additional aspects, the method may reside in any combination of a tray manufacturer, tray provider, product/service provider, advertising agency, or any other entity capable of being involved in an advertising or promotional event in direct relation to the tray entering into agreements, proposing campaigns, negotiating agreements, and securing the placement of trays in airports, cafeterias, or any facility in which the tray is usable. Any of the additional aspects may also include periodically performing one of replacing the advertising material in the trays and collecting the trays from the airport and replacing them with different trays having different advertising material.

Preferably, the above-described method includes providing targeted advertising to particular groups. For example, where the trays are security trays supplied to an airport for use at security checkpoints, the advertising provided in the trays may contain content unique to the area the airport is located in. Conversely, the advertising content may be directed to goods or services that are available at a particular destination that corresponds to particular security checkpoints. Moreover, the advertising may be different depending on whether or not the particular checkpoint caters to first class or economy class travelers.

The method described herein may also include providing a centralized facility where depending on the final destination, different advertising material is mounted to different trays with the trays being shipped to their final destination from the central facility. Such a method may also require that personnel be located at the particular facility to place the trays at the appropriate locations. In lieu of a centralized facility, a facility can be located on site with the advertising being supplied to the facility or printed at the facility as needed. The trays can also be supplied to or recycled at the on site facility. Of course this would only be practical where large numbers of trays are used, such as at an airport.

One particular advantage of the present invention resides in the fact that unused space can be used to enlighten a traveler regarding a particular product or service. The space in the bottom of a tray used at an airport security checkpoint is fertile ground for conveying a message (most desirably a message touting the benefits of a particular product or service). By tapping this resource, product/service providers are able to introduce their products and services to a larger group of potential purchasers or users.

Another advantage of the present invention is that the advertising services described herein can provide a source of revenue for the facility utilizing such services. For example, because of increased security protocols in airline screening processes, many travelers are looking at alternate modes of travel in order to avoid the hassles associated with airports. Thus, airports are finding it increasingly difficult to maintain service facilities such as carrier service as well as food and retail services. By providing the airport with an income stream from the leasing of unused space for advertising materials, many airports can offset their financial losses.

### BRIEF DESCRIPTION OF THE DRAWINGS

FIG. 1 is a perspective view of a tray of the present invention having advertising material incorporated into a bottom surface thereof.

FIG. 2 is an exploded cross sectional view of the tray of FIG. 1.

FIG. 3 is a perspective view of one embodiment of the engagement of an advertising material cover with a tray of the present invention.

FIG. 4 is a perspective exploded view of a tray of the present invention having advertising materials and a cover retained therein using a channel.

FIG. 5 is a perspective exploded view of a tray of the present invention having advertising materials and a cover retained therein using snaps.

FIG. 6 is a perspective view of a tray of the present invention having advertising materials incorporated into walls thereof.

FIG. 7 is a perspective view of a tray of the present invention having advertising materials printed directly thereon.

FIG. 8 is a perspective exploded view of a tray of the present invention having advertising material printed directly on a cover, the cover being snapped into the tray.

FIG. 9 is a perspective view of a cover of the present invention in which advertising material is printed on both sides thereof.

FIG. 10 is an exploded cross sectional view in which a conventional non-advertising tray is modified to incorporate advertising material.

FIG. 11 is a schematic representation of a method of providing an advertising service of the present invention.

FIG. 12 is a schematic representation of a step of removing advertising material from a tray.

FIG. 13 is a schematic representation of a collection of revenue from the method of providing an advertising service.

FIG. 14 is a schematic representation of a method of providing an advertising service initiated by an airport.

FIG. 15 is a schematic representation of a method of providing an advertising service initiated by an advertising agency.

FIG. 16 is a schematic representation of a method of providing an advertising service initiated by a joint venture between an airport and an advertising agency.

FIG. 17 is a schematic representation of a method of providing an advertising service initiated by a joint venture of a tray manufacturer and a product/service provider.

FIG. 18 is a schematic representation of a method of providing an advertising service initiated by an agreement between a travel facility, a product/service provider, and an authoritative agency.

### DETAILED DESCRIPTION OF THE PREFERRED EMBODIMENTS

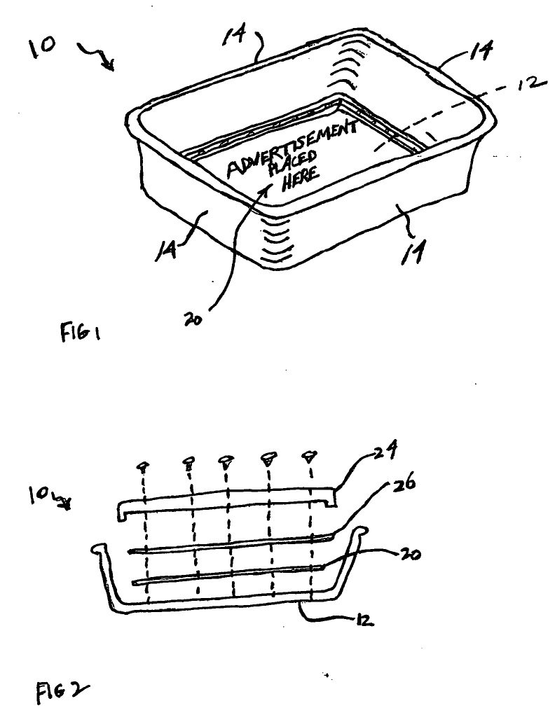

As shown in FIG. 1, a tray having advertising material incorporated therein is generally referred to by the reference number 10. Tray 10 comprises a substantially planar bottom surface 12 and four upstanding walls 14. Advertising material 20 is positioned on the bottom surface 12 such that a person looking at the tray can easily view the advertising material while placing articles in or removing articles from the tray 10. Preferably, the advertising material 20 is printed on paper or other sheet-type material, however the present invention is not limited in this regard.

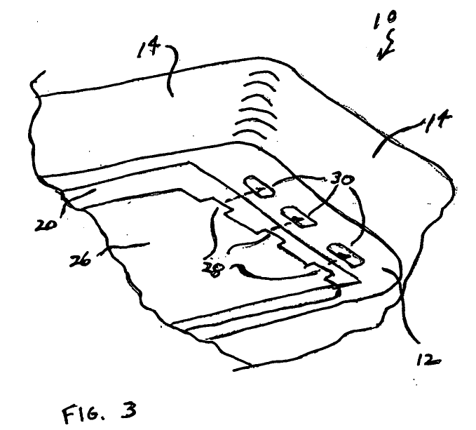

One manner in which the advertising material 20 may be mounted to the tray 10 is shown with reference to FIG. 2. The advertising material 20 is mounted to the planar member 12 using a frame 24. The advertising material 20 may be held in place solely by the frame 24, or it may be snappingly held in place, held in place magnetically, with an adhesive, or with hook-and-loop material. The frame 24 is bolted, screwed, or otherwise fastened to the tray bottom 12. In the alternative, the advertising material 20 may be adhesively positioned over previously positioned advertising materials without the use of a frame or fasteners. When advertising materials are positioned in such a manner, the trays 10 are periodically removed from the facility and taken to another facility for removal of the accumulated advertising materials by a suitable process, such as steam cleaning or the like.

A cover 26 is fastened over the advertising material 20 between the frame 24 and the advertising material to protect the advertising material from being ripped, scuffed, or marred by the deposit of articles into the tray 10. In order for a person looking at the bottom surface 12 of the tray 10 to view the advertisement positioned thereon, at least a portion of the cover must be transparent or sufficiently translucent so that the desired advertisement can be viewed.

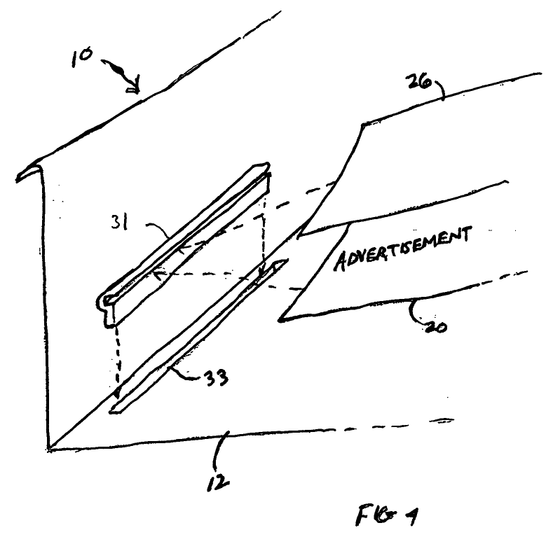

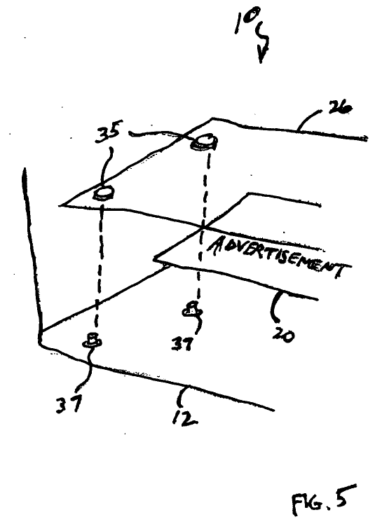

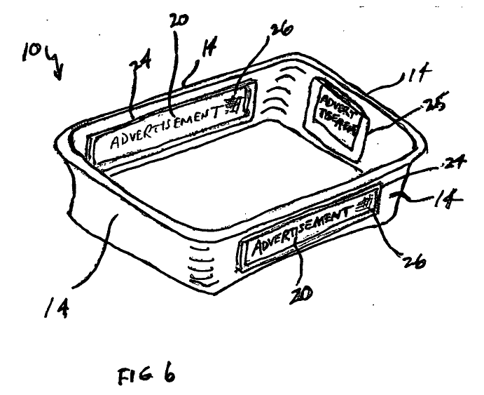

The cover 26 may be held in place using any one or a combination of means. Referring now to FIG. 3, tabs 28 formed on the edges of the cover 26 engage slots 30 in either the walls 14 or the planar member 12 and are frictionally retained therein to hold the advertising material 20 onto the tray 10. As is shown in FIG. 4, the cover 26 may be held in place on a tray 10 by being mounted in a channel 31 that is retained in the tray in a slot 33 on the tray using mechanical fasteners. The channel 31 extends along at least a portion of the periphery of the bottom surface 12. The advertisement 20 may be positioned under the cover 26 and also held in the channel 31. Referring to FIG. 5, snaps having first portions 35 and second portions 37, the first and second portions being snappingly engageable with each other, may also be incorporated into the cover 26 and the bottom surface 12 to facilitate the mounting of the cover 26 to the tray 10. As above, the advertisement 20 may be held under the cover 26 in a press-fit, or it may also be held with the snaps. In any embodiment, the cover 26 may be any flexible material in sheet form that has sufficient optical properties. Exemplary materials include, but are not limited to, methyl methacrylates, polycarbonates, cellulose acetate butyrates, glycol-modified polyethylene terphthalates, and the like.

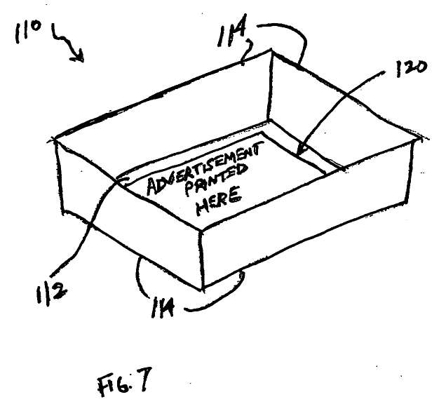

Referring now to FIG. 6, the advertising material 20 may be mounted to a wall 14 of the tray 10. As shown, advertising materials 20 may be mounted in a frame 24 on an outer surface of the wall 14, an inner surface of the wall, any combination of inner and outer surfaces of the walls, or any number of walls. When the advertising materials 20 are mounted to the walls 14 of the tray 10, they may be mounted using frames 24 and covered with see-through covers 26, into pockets (as shown at 25) attached to the trays, or mounted directly to the surfaces of the tray with adhesives or with hook-and-loop material.

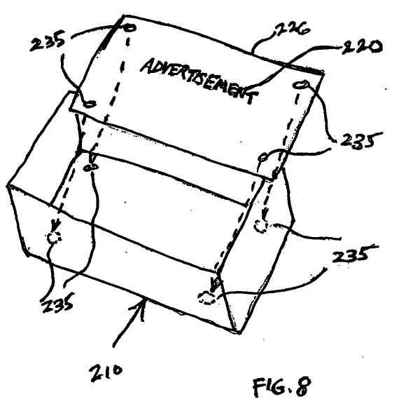

Referring now to FIG. 7, a tray having an advertising material incorporated therein is shown generally at 110. Tray 110 is manufactured from a material that is folded or can be assembled to have a substantially planar bottom surface 112 and at least one upstanding wall 114. The shape of the tray 110 is sufficient for retaining articles at security checkpoints. At least one advertising material 120 is printed directly on either or both the bottom surface 112 or the wall 114. Alternately, or additionally, the advertising material 120 may be adhesively mounted on either or both the bottom surface 112 or the wall 114. Preferably the material from which the tray 110 is manufactured is easily disposable, recyclable, and inexpensive so that when the useful life of the tray 110 is expended the tray can be easily replaced. Preferably, the material from which the tray 110 is manufactured is cardboard.

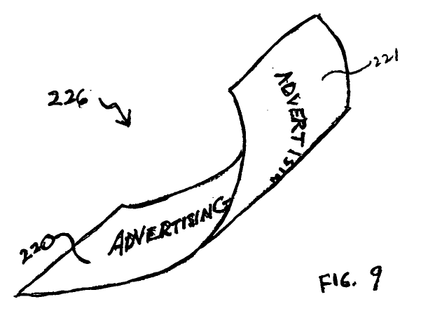

In FIGS. 8 and 9, advertising material 220 may be printed directly on a cover 226 made from any suitable material and attached to a tray 210 using mechanical means such as snaps 235 or other mechanical fasteners or by using frictional fit means such as channels, slots and tabs, or the like. In any embodiment, as is shown in FIG. 9, the advertising material may be printed on both sides of the cover 226 such that a first advertisement 220 can be displayed for a selected period of time and the cover can be turned over to display a second advertisement 221 for a selected period of time.

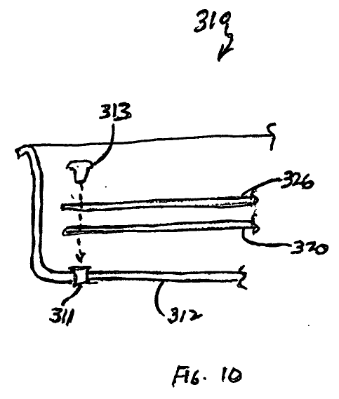

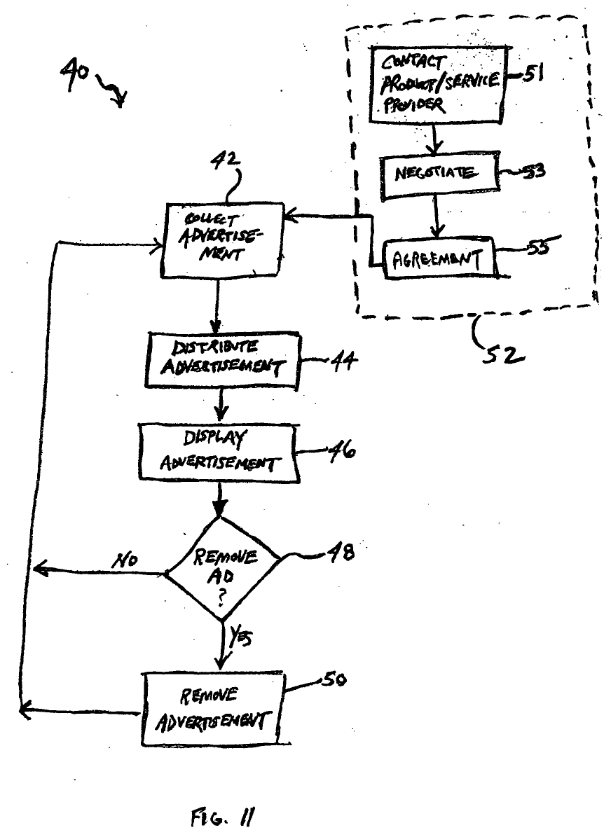

Referring to FIG. 10, existing non-advertising trays 310 may be modified to have advertising materials 320 attached thereto adhesively or by, for example, mounting an anchor 311 into a bottom surface 312 of the tray and attaching a corresponding connector 313 thereto such that when attached, the anchor and connector retain a cover 326 on the bottom surface. The advertising material 320 may be mounted under the cover 326 adhesively, in a press-fit, or by being mounted to the bottom surface 312 using the same anchor 311 and connector 313, as is shown.

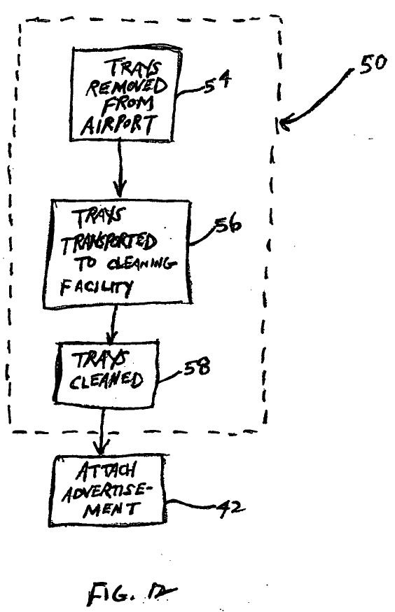

A method of providing an advertising service is shown generally at 40 with reference to FIG. 11. In the method, advertising material is determined, trays having the advertising material incorporated therein are provided and supplied to a facility (e.g., a travel facility such as an airport, a cafeteria, or the like), and the advertising material is periodically replaced (either at the facility or after collecting the trays from the facility). The method 40 generally comprises the steps of collecting advertising materials in a collecting step 42, distributing the collected advertising materials in a distribution step 44, and displaying the distributed advertising materials in the trays (airport security trays or cafeteria-style trays) in a display step 46. The method further comprises making a decision regarding whether to remove the displayed advertising material in a decision step 48 and either proceeding with collecting another advertising material in the collecting step 42 or removing the displayed advertising materials in a removal step 50 before proceeding with collecting another advertising material. In determining the advertising material, the collecting step 42 may comprise physically receiving the advertising materials from the product/service provider, or it may comprise receiving authorization from the provider to have the advertising materials reproduced by a third party. The distribution step 44 may comprise the printing of the advertising material at the facility using a computer or other device having a desktop publishing function.

Advertising materials are provided from product/service providers in advertising material providing step 52. In the material providing step 52, potential product/service providers are contacted in a contact step 51. Agreements pertaining to the particulars of the tray advertising process are negotiated in a negotiation step 53, and an agreement is desirably reached in an agreement step 55. As used herein, the term “negotiation” indicates the making of any offer and acceptance. The agreement reached may define parameters such as which party supplies the concepts for the advertising material, the responsibilities of the product/service provider, the responsibilities of the respective advertisement supplier(s) and distributor(s) as well as tray management services, and the relevant associated financial and accounting processes.

Although only one advertising material providing step 52 is shown, it should be understood that any number of product/service providers may provide advertising materials. Product/service providers can be selected such that the advertising can be targeted to consumer groups endemic to a particular destination or the area surrounding the airport. In addition, if separate screening processes are instituted for travelers flying in different classes on the same airplane, the advertising materials can be targeted to the travelers of each particular class. For example, first class travelers may have one advertising material shown in the trays used in the screening process and business class or economy class travelers may have a different advertising material shown in the trays. Furthermore, advertising materials can be seasonally or popularly directed to travelers. Alternately, public service messages and warnings can be directed to travelers.

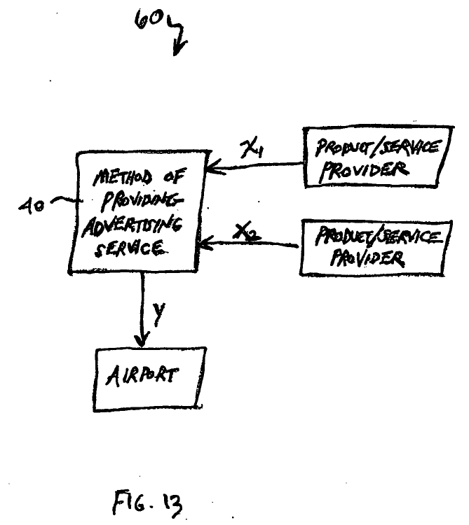

In the decision step 48, a query is made regarding whether the advertising material being displayed is to be removed prior to the display of a subsequently posted advertising material. In particular, in embodiments of the tray in which advertising materials are pasted over previously posted advertising materials and the response to the query is “yes,” the removal step 50 is executed. Referring now to FIG. 12, the removal step 50 comprises removing the trays from the airport in a tray removal step 54, transporting the removed trays to a cleaning facility in a transport step 56, and cleaning the trays in a cleaning step 58. As stated above, the cleaning step 58 may comprise cleaning the trays with steam to remove the accumulated advertising materials. Other methods of cleaning the trays may also be used, such as soaking the trays in water, scraping the accumulated advertising materials, using ultrasound techniques to loosen the adhesive, or combinations of the foregoing. The trays are ultimately returned to the airport.

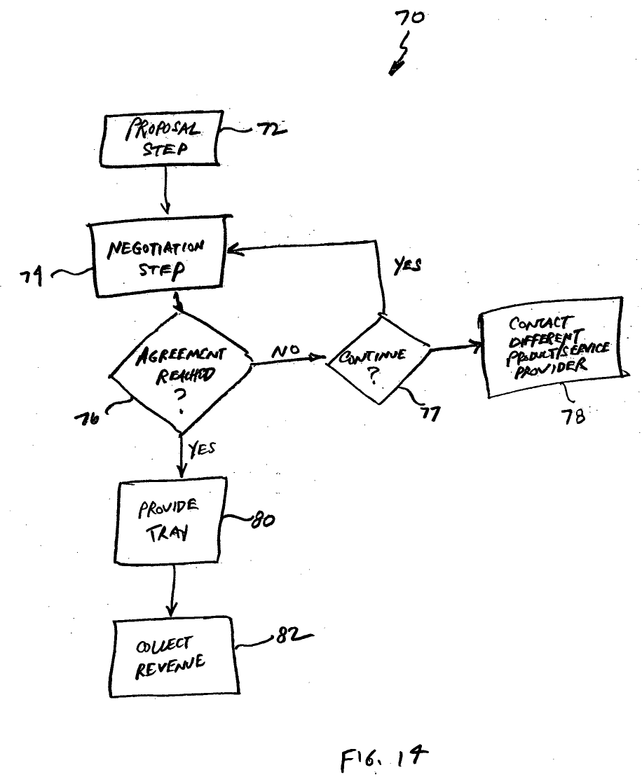

Referring now to FIG. 13, the collection of revenue from the operation of the method of providing the advertising service 40 is shown at 60. The collection of revenue 60 comprises receiving income streams from product/service providers and making payouts as compensation for advertising space leased. Although any number of income streams may be received from product/service providers, only two income streams are shown at x₁ and x₂. Although any number of payouts may be made to users of the trays, only one payout stream is shown at y. Preferably, the total value of the income streams exceeds the total value of the payout streams.

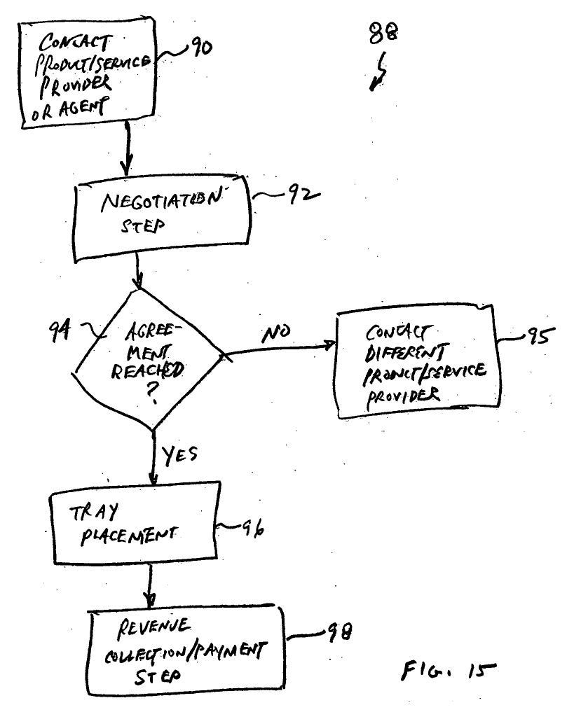

Referring to FIG. 14, a method of providing an advertising service initiated by the airport (or facility using cafeteria-style trays) is shown generally at 70. In the method 70, the airport proposes a tray advertising campaign in a proposal step 72. The proposal may be made directly to a product/service provider either through direct contact with the provider or through an advertising scheme in which the airport solicits offers from various providers. The airport negotiates with the product/service provider (or an agent of the provider) in a negotiation step 74 to arrive at an agreement step 76. If an agreement is not reached, a decision is made regarding whether to continue or not in a continuation step 77. The negotiation step 74 may be revisited, or a different product/service provider may be contacted in a contact step 78. A different product/service provider may be contacted in the contact step 78 irrespective of the outcome of the agreement step 76 to secure additional advertising. If an agreement is reached (e.g., the specifications of the advertising material are determined, the periods of time for which the advertising material is to be displayed before changing, and the like), trays are secured and provided in a tray providing step 80. The trays may be secured by the airport from any suitable tray provider. The airport then collects revenue from the product/service provider in a revenue collection step 82.

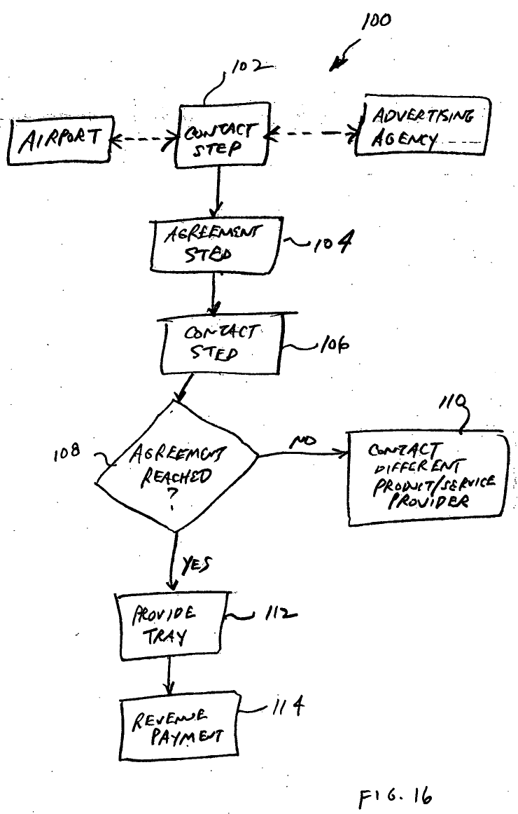

A method of providing an advertising service initiated by an advertising agency is shown at 88 with reference to FIG. 15. In the method 88, an advertising agency contacts a product/service provider (or an agent thereof) in a contact step 90, negotiates with the provider in a negotiation step 92, and makes a decision in a decision step 94. If an agreement regarding the advertising is not reached, a different product/service provider may be contacted in a second contact step 95. If an agreement is reached, the advertising agency secures the placement of trays containing the advertising in an airport in a tray placement step 96. The advertising agency then collects fees from the product/service provider and pays fees to the airport in a revenue collection/payment step 98.

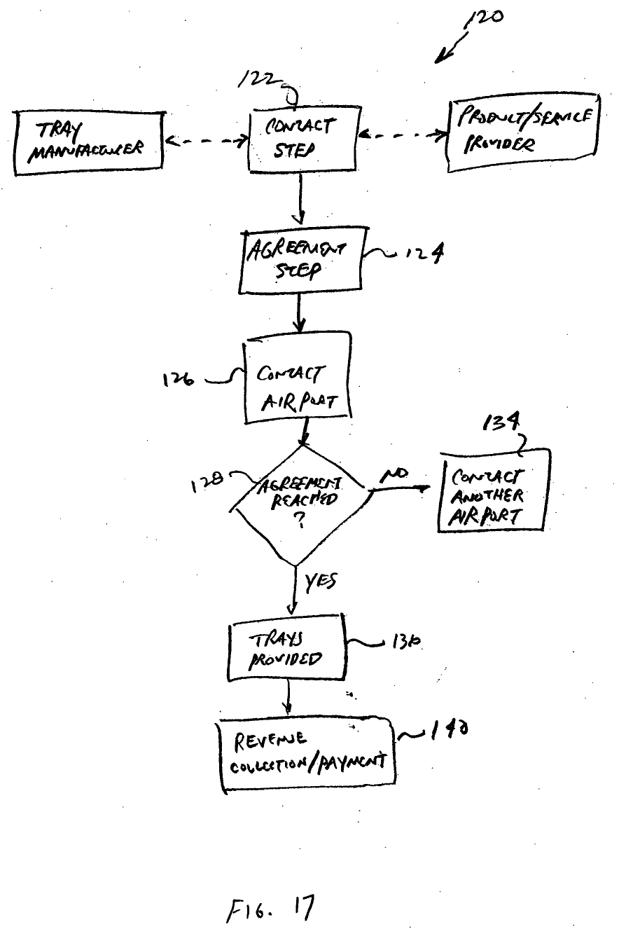

Referring now to FIG. 16, a method of providing an advertising service initiated by a joint venture of an airport and an advertising agency is shown generally at 100. In the method 100, either an airport contacts an advertising agency or an advertising agency contacts an airport in a contact step 102. An agreement is reached in an agreement step 104 regarding the particulars of the responsibilities of each party. A product/service provider is then contacted in a contact step 106, and various advertising scenarios may be proposed. A decision is then made in an agreement step 108 regarding how to proceed with the advertising. If an agreement is not reached another product/service provider may be contacted in a second contact step 110. If agreement is reached, trays are secured and provided in a tray providing step 112. The product/service provider then pays the airport and the advertising agency in a revenue payment step 114.

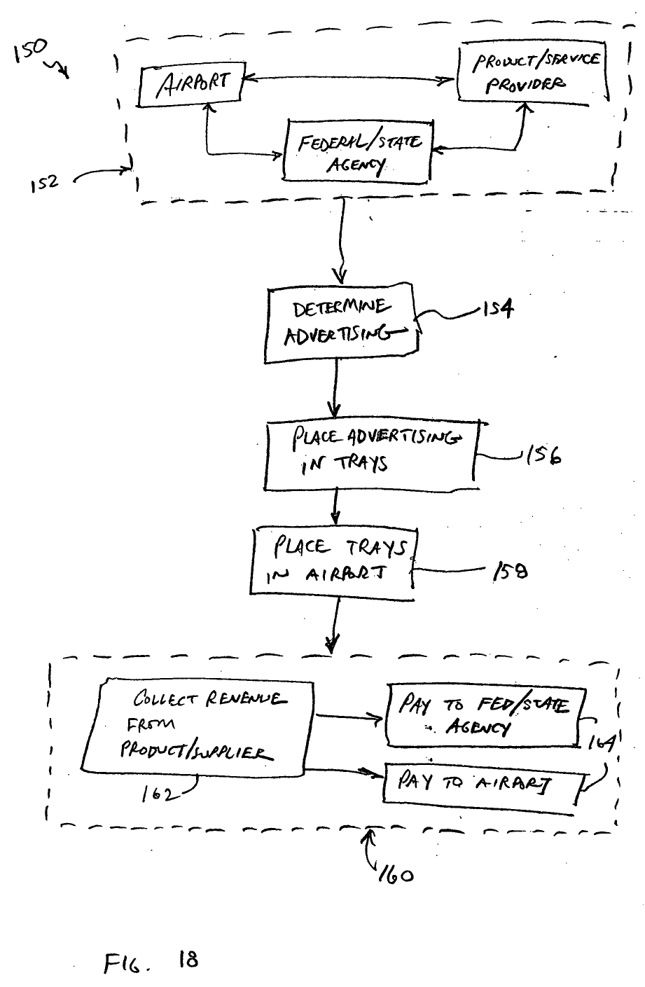

Referring now to FIG. 17, a method of providing an advertising service initiated by a joint venture of a tray manufacturer and a product/service provider is shown generally at 120. In the method 120, either a tray manufacturer contacts a product/service provider or a product/service provider contacts a tray manufacturer in a contact step 122. An agreement is reached in an agreement step 124 regarding the particulars of the responsibilities of each party, e.g., which party initiates contact with an airport either directly with the airport or through an advertising agency. The airport is then contacted in a contact step 126 either directly with the airport or through the advertising agency. A decision is made in a decision step 128 regarding the particulars of the advertising services to be provided. If no agreement is reached with the airport, another airport may be contacted in a second airport contact step 134. If an agreement is reached with the airport, trays are provided to the airport in a tray providing step 136, such trays having the advertising material incorporated therein or printed thereon per the specifications of the product/service provider. In a revenue collection/payment step 140, revenue is collected from the product/service provider and paid to the tray manufacturer and the airport.

Referring now to FIG. 18, a method of providing an advertising service at a travel facility initiated by an agreement between an authoritative agency such as a federal agency or a state agency, the travel facility, and a product/service provider is shown generally at 150. The travel facility is preferably an airport and is hereinafter referred to as being an airport, but may be a shipping port, a train station, or the like. The agreement is determined in an agreement step 152, which may constitute any combination of the federal or state agency, the airport, and the product/service provider entering into an agreement to provide trays having advertising material as described above mounted therein. The agreement step 152 may comprise any two of the foregoing entities entering into an agreement and approaching the third entity, or it may comprise all three entities simultaneously entering into an agreement through equilateral negotiations. Negotiations may be made through agents specifically designated for such purposes, i.e., negotiations with the product/service provider may be made via an advertising agency. Upon agreeing to provide the trays, the advertising is determined in an advertising determination step 154, advertising materials are placed in trays in an advertising placement step 156, and the trays are provided to the airport in a tray placement step 158. In an accounting step 160, revenue is collected from the product/supplier in a collection step 162 and paid to at least one of the federal or state agency and the airport in payout steps 164. Federal agencies that may be included in the method 150 include, but are not limited to, the Transportation and Safety Administration, the Federal Aviation Administration, the Department of Homeland Security, and the like.

In any of the above-described embodiments, the trays may be periodically replaced with different trays incorporating different advertising material, or the advertising in the trays may be replaced. In either scenario, the advertising material may be targeted to particular persons based on the demographics of the airport. If the advertising material is replaced, the replacement may be made by airport personnel or personnel associated with the advertising agency.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A method for an airport to provide an advertising service using airport security trays, said trays having advertising material displayed thereon, said method comprising the steps of:
proposing an advertising campaign to a product/service provider;
negotiating an agreement with said product/service provider;
providing a plurality of trays, each defining at least one generally exposed surface, each tray having a cover releasably coupled thereto, at least a portion of said cover extending over at least a portion of said exposed surface, wherein said cover is one of at least partially transparent and at least partially translucent to allow desired portions of advertising material, when such is positioned between said exposed surface and said cover, to be viewed by a person looking at said tray;
determining said advertising material to be used with said plurality of trays and positioning said advertising material between said exposed surface of each of said trays and said corresponding cover;
supplying at least a portion of said plurality of trays having said advertising material positioned therein for use in said airport; and
periodically performing one of replacing said advertising in said plurality of trays and collecting said plurality of trays from said airport and replacing them with a plurality of different trays having different advertising mounted thereto.

2. The method of claim 1, wherein said step of proposing said advertising campaign to said product/service provider comprises said airport making said proposal directly to at least one of said product/service provider and an agent of said product/service provider.

3. The method of claim 1, wherein said proposing said advertising campaign comprises contacting a second potential product/service provider.

4. The method of claim 1, further comprising collecting revenue from said product/service provider.

5. A method for an advertising agency to provide an advertising service to a facility via a plurality of trays, each tray having advertising material displayed thereon, said method comprising the steps of:
contacting a product/service provider;
proposing an advertising campaign to said product/service provider;
negotiating an agreement with said product/service provider;
securing the placement of said trays in said facility; and
periodically performing one of replacing said advertising material in said plurality of trays and collecting said plurality of trays from said facility and replacing them with a plurality of different trays having different advertising mounted thereto.

6. The method of claim 5, further comprising contacting a second product/service provider.

7. The method of claim 5, further comprising collecting revenue from said product/service provider and paying revenue to said facility.

8. A method for providing an advertising service to an airport via a plurality of trays, each tray having advertising material displayed thereon, said method comprising the steps of:
initiating a joint venture between said airport and an advertising agency;
proposing an advertising campaign from said joint venture to a product/service provider;
negotiating an agreement with said product/service provider;
securing the placement of said trays in said airport; and
periodically performing one of replacing said advertising material in said plurality of trays and collecting said plurality of trays from said airport and replacing them with a plurality of different trays having different advertising mounted thereto.

9. The method of claim 8, wherein said initiating said joint venture comprises one of said airport contacting said advertising agency and said advertising agency contacting said airport.

10. The method of claim 8, further comprising reaching an agreement regarding the particulars of the responsibilities of said airport and said advertising agency.

11. The method of claim 8, further comprising providing said trays within specifications defined by said product/service provider.

12. The method of claim 8, further comprising collecting revenue from said product/service provider and paying revenues to said airport and said advertising agency.

13. A method for providing an advertising service to an airport via a plurality of trays, each tray having advertising material displayed thereon, said method comprising the steps of;
initiating a joint venture between a tray manufacturer and a product/service provider;
proposing an advertising campaign from said joint venture to said airport;
negotiating an agreement with said airport;
securing the placement of said trays in said airport; and
periodically performing one of replacing said advertising material in said plurality of trays and collecting said plurality of trays from said airport and replacing them with a plurality of different trays having different advertising mounted thereto.

14. The method of claim 13, wherein said initiating said joint venture comprises one of said tray manufacturer contacting said product service/provider and said product/service provider contacting said tray manufacturer.

15. The method of claim 13, wherein said proposing said advertising campaign to said airport is effected through an advertising agency.

16. The method of claim 13, further comprising reaching an agreement regarding the particulars of the responsibilities of said tray manufacturer and said product/service provider.

17. The method of claim 13, further comprising providing said trays within specifications defined by said product/service provider.

18. The method of claim 13, further comprising collecting revenue from said product/service provider and paying revenues to said airport and said tray manufacturer.

19. The method of claim 13, further comprising proposing said advertising campaign to said airport through an advertising agency.

20. A method for providing an advertising service using trays, said trays having advertising material displayed thereon, said method comprising the steps of:
proposing an advertising campaign to a product/service provider;
negotiating an agreement with said product/service provider;
providing a plurality of trays, each defining at least one generally exposed surface, each tray having a cover releasably coupled thereto, at least a portion of said cover extending over at least a portion of said exposed surface, wherein said cover is one of at least partially transparent and at least partially translucent to allow desired portions of advertising material, when such is positioned between said exposed surface and said cover, to be viewed by a person looking at said tray;
determining said advertising material to be used with said plurality of trays and positioning said advertising material between said exposed surface of each of said trays and said corresponding cover;
supplying at least a portion of said plurality of trays having said advertising material positioned therein; and
periodically performing one of replacing said advertising in said plurality of trays and collecting said plurality of trays and replacing them with a plurality of different trays having different advertising mounted thereto.

21. The method of claim 20, wherein said step of proposing said advertising campaign to said product/service provider comprises a facility in which said trays are used making said proposal directly to at least one of said product/service provider and an agent of said product/service provider.

22. The method of claim 20, wherein said proposing said advertising campaign comprises contacting a second potential product/service provider.

23. The method of claim 20, further comprising collecting revenue from said product/service provider.

24. A method for providing an advertising service at a travel facility using trays, said trays having advertising material displayed thereon, said method comprising the steps of:
entering into an agreement between said travel facility, a product/service provider, and an authoritative agency to provide an advertising service;
determining advertising material to be incorporated into said trays;
placing said advertising material into said trays;
providing said advertising trays to said travel facility;
accounting for revenue collected in exchange for said advertising service.

25. The method of claim 24, wherein said authoritative agency is selected from the group consisting of the Transportation and Safety Administration, the Federal Aviation Administration, and the Department of Homeland Security.

26. The method of claim 24, wherein said accounting for said revenue collected comprises collecting revenue from said product/service provider.

27. The method of claim 24, wherein said accounting for said revenue collected comprises paying revenue to at least one of said travel facility and said authoritative agency.
